(19) United States
(12) Patent Application Publication
(10) Pub. No.: US 2004/0153439 A1
(43) Pub. Date: Aug. 5, 2004

(54) Server, data providing method, medium and program

(75) Inventor: Tadashi Kagesawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/763,261

(22) Filed: Jan. 26, 2004

Related U.S. Application Data
(63) Continuation of application No. PCT/JP01/06496, filed on Jul. 27, 2001.

(51) Int. Cl. G06F 7/00

(52) U.S. Cl. 707/1

(57) ABSTRACT

An apparatus receiving request data from a request source and providing response data corresponding to the request data, comprises a control information recording unit recording control information related to an area of which data is restricted from being provided; an edit unit creating, when the data should be provided as the response data, the response data in accordance with the control information by hiding the data area restricted from being provided; and a transmitting unit providing the response data.

### TECHNICAL FIELD

The present invention relates to a technology for providing data.

### BACKGROUND ARTS

Over the recent years, multiplicities of Web sites have opened on networks, wherein there are provided contents and information that contain various categories of data.

On these Web sites, in the case of disclosing the contents and the information to the public on the networks, there might be a case of having no desire for disclosing all of the contents and the information as they are to the public. For example, if the content is image data, there might be a case of desiring to disclose the image data in a way that hides a part of the image.

In such a case, however, the image data from which a want-to-hide part is deleted have hitherto been separately created, the thus separately created image data had to be disclosed to the public.

Further, there might be a case of desiring to provide such information to only limited persons without disclosing the information to all the persons on the network. In this instance, there might be a case of desiring to change a range for limiting the information and a degree of limitation, depending on a destination to which the information is provided.

Hitherto, however, the information with its content limited had to be created separately, and the thus separately created information had to be provided depending on the information providing destination

On the other hand, for a tag-structured text as by HTML, there is proposed a function of deleting a structured element unit, e.g., a link destination in accordance with an unaccessible list and providing a described content of the HTML text (for example, Japanese Patent Application Laid-Open Publication No.11-242639).

It was, however, impossible to control whether a part of the image of the link destination should be or should not be disclosed (opening/non-opening) to the public.

### DISCLOSURE OF THE INVENTION

The present invention was devised in view of the problems to the prior arts given above. Namely, an object of the present invention lies in providing a function of disclosing image data, etc. in a way that partially restricts them.

Further, an object of the present invention lies in enabling, in the case of providing data on a network, a partial restriction of the data provided depending on a providing destination.

To accomplish the above objects, there present invention adopted the following means. Namely, the present invention is an apparatus (server (1)) receiving request data from a request source and providing response data corresponding to the request data, comprising a control information recording unit (13) recording control information related to an area of which image data is restricted from being provided, an edit unit (11-15) creating, when the response data contains the image data, the response data in accordance with the control information in a way that hides the image data area restricted from being provided, and a transmitting unit providing the response data.

Further, the present invention may also be a server (1) receiving request data from a request source and providing response data corresponding to the request data, comprising a request source recognizing unit recognizing the request source, a control information recording unit (13) recording control information related to data restricted from being provided depending on the request source, an edit unit (11-15) creating the response data corresponding to the request data in accordance with the control information in a way that hides information restricted from being provided, and a transmitting unit providing the response data.

Preferably, the above control information contain may contain information for identifying the request source, and designating information for designating a data area restricted from being provided to the request source.

Preferably, the above designating information may also be display area information for indicating the area restricted from being provided.

Preferably, when the data is an image, the designating information may also be a partial image, specifying an object restricted from being provided, in this image.

Preferably, the above server may further comprise an input unit (4) setting the control information.

Moreover, the present invention may also be a data providing method receiving request data from a request source and providing response data corresponding to the request data, comprising a step (S3) referring to control information related to an area of which image data is restricted from being provided, a step (S4, S6) creating, when the response data contains the image data, the response data in accordance with the control information in a way that hides the image data area restricted from being provided, and a step (S7) providing the response data.

Still further, the present invention may also be a program making a computer actualize any one of the functions given above. Yet further, the present invention may also be a readable-by-computer storage medium recorded with the program described above.

### BRIEF DESCRIPTION OF THE DRAWINGS

FIG. 1 is a diagram of a principle of a hiding process in an embodiment of the present invention;

FIG. 2 is a view of an architecture of an information system in the embodiment of the present invention;

FIG. 3 shows an example of operation of setting hiding information 13 in a WWW server 1 shown in FIG. 2;

FIG. 4 shows an example 1 (a case of designation of coordinates) of a data structure of the hiding information 13 shown in FIG. 1;

FIG. 5 shows an example 2 (a case of designation of search image) of the data structure of the hiding information 13;

FIG. 6 is a flowchart showing a procedure of the hiding process executed on the WWW server 1 shown in FIG. 2; and

FIG. 7 is a flowchart showing details of the hiding process with respect to a content to be provided, shown in FIG. 6.

### BEST MODE FOR CARRYING OUT THE INVENTION

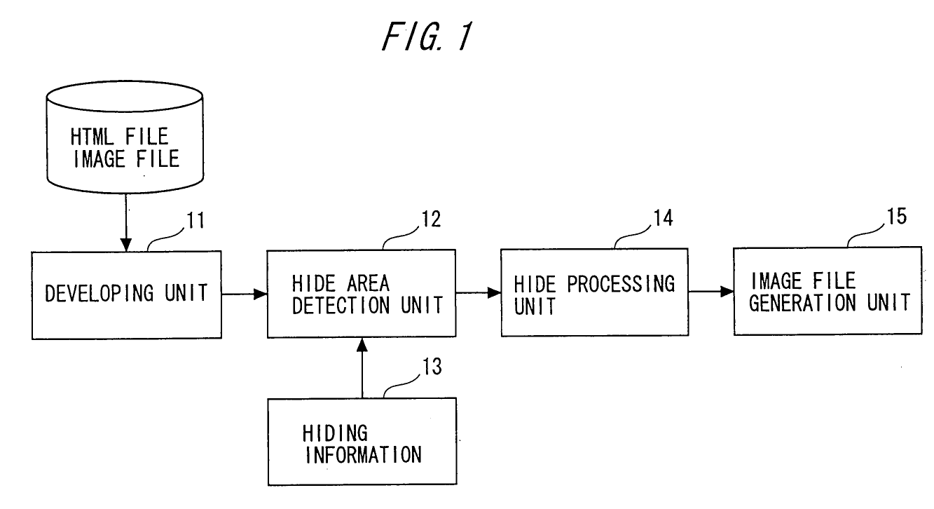

A preferred embodiment of the present invention will hereinafter be described with reference to the drawings in FIGS. 1 through 7.

FIG. 1 illustrates a principle of a hiding process in this embodiment. FIG. 1 shows the principle of the hiding process executed on a WWW (World Wide Web) server for providing contents such as images, texts, etc. on the Internet.

As shown in FIG. 1, this hiding process is actualized by a developing unit 11 for reading an HTML file and an image file and developing these files into bitmaps, a hide area detection unit 12 for detecting a hide area on the developed bitmap, hiding information 13 for designating the hide area for the aforementioned hide area detection unit, a hide processing unit 14 for hiding the hide area on the bitmap developed by the developing unit 11, and an image file generation unit 15 for generating an image file in which the hide area is hidden.

The WWW server 1 receives requests for various categories of contents from clients on the Internet, executes the hiding process for the content, and provides the content after the hiding process.

The developing unit 11 converts the contents in a variety of formats, e.g., the HTML file and the image file into bitmap-formatted image files. This bitmap-formatted image file is transferred to the hide area detection unit 12.

The hide area detection unit 12 refers to the hiding information 13, and thus detects an area that should be hidden on that bitmap-formatted image. In the hiding information 13, a should-be-hidden image area, a should-be-hidden image shape, etc. are designated for every client that has transmitted the request and for every requested content. Setting all the clients as objects, however, the should-be-hidden image area, the should-be-hidden image shape, etc. may also be designated.

The hide processing unit 14, with respect to the bitmapped image, hides the hide area detected by the hide area detection processing unit 12. The image generation unit 14 converts the bitmapformatted image having undergone the hiding process back into the same file format as at the beginning.

<System Architecture>

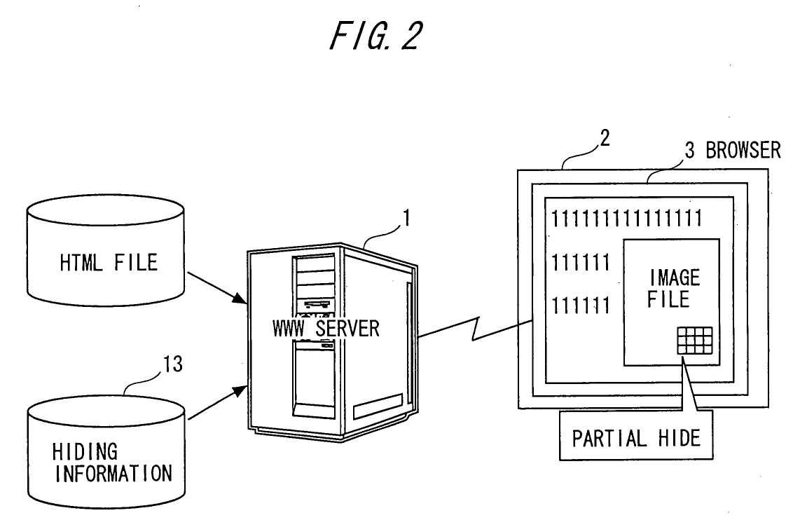

FIG. 2 is a view of an architecture of an information system for distributing the various categories of contents in a way that executes the hiding process shown in FIG. 1. This system is configured of the WWW server 1 for distributing the contents stored as the HTML files, the image files, etc., and a client 2 sending a request to this WWW server 1 via the network and receiving the content.

The WWW server 1 receives the request from the client 2 and provides the content as an object of this request. The WWW server 1 is constructed of a computer having a CPU, a memory, a hard disk, a communication board, etc., and if a server program for processing the requests from the clients 2. Such a construction of the WWW server 1 is highly well known nowadays, and hence its explanation is omitted.

The contents provided by the WWW server 1 are stored in the forms of the HTML file, the image file, etc. on the hard disk of the WWW server 1 itself and hard disks of other servers.

The WWW server 1 analyzes the request of the client 2 and sends, as a response thereto, the requested content. On this occasion, the WWW server 1 refers to the hiding information 13 and hides the hide area designated by the hiding information 13.

The client 2 is one of a personal computer, a PDA (Personal Digital (Data) Assistants, Personal Digital Assistance), a cellular phone, a PHS (Personal Handyphone System) and so on. Their constructions are widely known at the present time, and therefore explanations thereof are omitted.

The client 2 executes Browser 3 on the unillustrated CPU, thereby accessing the various categories of contents provided by the WWW server 1. In this case, the Browser 3 sends the request to the WWW server and receives the HTML-described content as a response thereto. Then, the Browser 3 displays the received content on a screen of the client 2.

In the present embodiment, however, as described above, the WWW server 1 hides a part of the content as the hiding information 13 shows. Accordingly, such a content is displayed by the Browser 3, as shown in FIG. 2, with the content being partially hidden.

<Operation of Setting Hide Area>

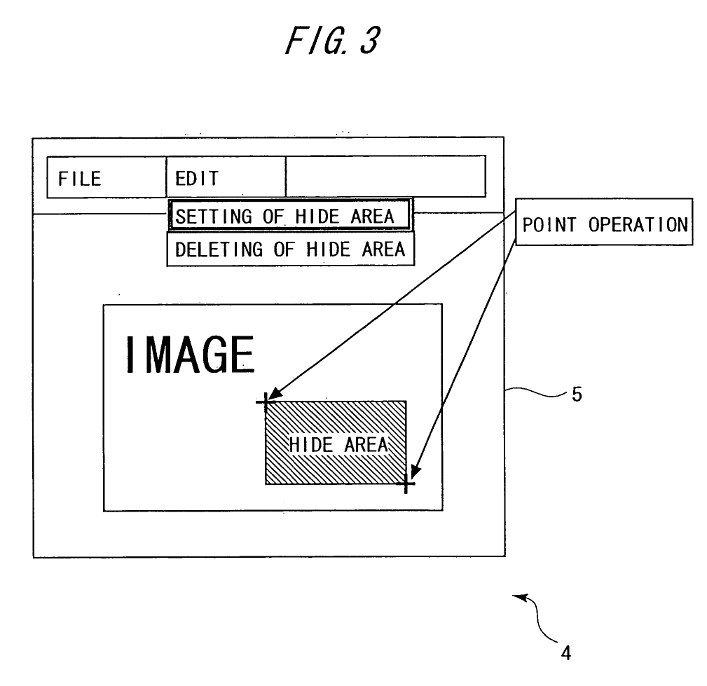

FIG. 3 shows an operation screen of a hiding editor 4 for setting the hide area in a text.

This hiding editor 4 is, in order to partially restrict the disclosure to the public by the WWW server 1, used for setting the hide area in the data as an object for the disclosure to the public. The hiding editor 4 has “file” and “edit” as menu items.

The user, to begin with, selects the data, for example, the HTML file and the image file in which the hide area is set. Such a file is called a hiding target file. Contents of the selected file are displayed in a display section 5 of the hiding editor 4.

Next, the user selects “hide area setting” from the “edit” menu. Then, the user specifies a should-be-hidden area of the contents (HTML-described contents and images) displayed in the display section 5 by use of an unillustrated pointing device.

Further, the user selects an unillustrated item “save” from the “file” menu. Then, the hiding editor 4 queries the user about an IP address of the client to which the hiding process for the hide area is applied.

When the user inputs the IP address, together with a file name of this hiding target file, coordinates of the specified area and the IP address are saved, thereby generating a piece of hiding information.

This piece of hiding information is applied to the client having the designated IP address. If the user does not designate the IP address, however, the aforementioned hiding information is applied to all the clients.

<Data Structure>

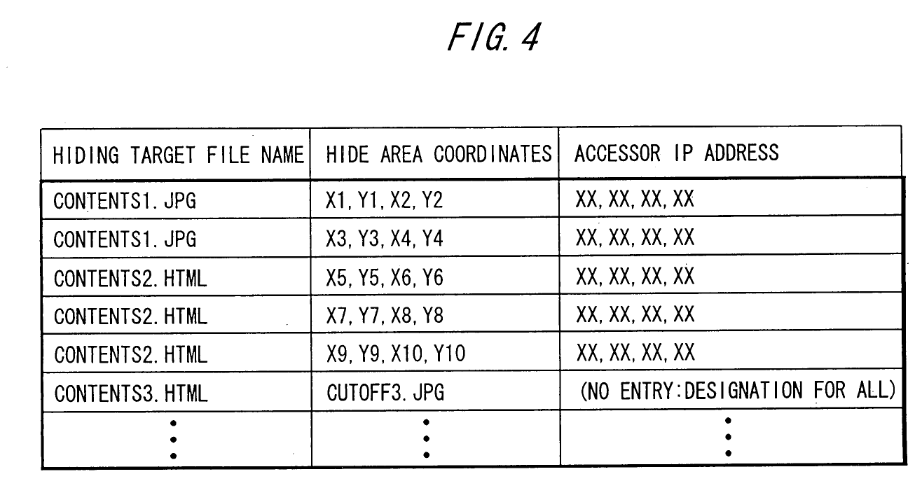

FIG. 4 shows an example 1 of a data structure of the hiding information. This piece of hiding information is retained in a table format, wherein each line has a hiding target file name, hiding area coordinates and an accessor IP address. One line of the hiding information in FIG. 4 defines one hidden area.

The hiding target file name is a file name containing a hiding target area. In FIG. 4, for instance, an image file such as CONTENTS1.JPG, etc., or an HTML file such as CONTENTS2.HTML, etc. is shown as the hiding target file.

The hiding area coordinates are coordinates that specify the hiding area in the image retained in the hiding target file or on the screen. In an example in FIG. 4, the hiding area coordinates specify the hiding area by a left upper point (X1, Y1, etc.) and a right lower point (X2, Y2, etc.) of a rectangular area. The hiding area coordinates may also be, however, designated by a string of apexes of a polygonal shape.

The accessor IP address is an IP address specifying the client that makes a request for the hiding target file. When the request for the hiding target file is given from the client specified by this accessor IP address, the WWW server 11 hides the area designated by the hide area coordinates, and sends the requested content back thereto.

As for a line containing no entry of the accessor IP address in the hiding information, however, the hiding target file and the hide area coordinates are designated with respect to all the clients. In this case, the area designated by the hide area coordinates is hidden with respect to all the clients accessing the hiding target file.

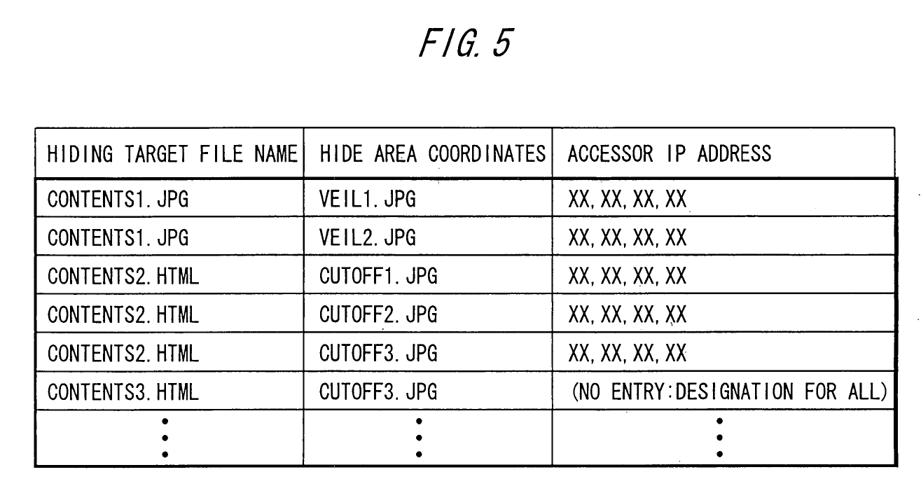

FIG. 5 shows an example 2 of the data structure of the hiding information for designating the hide area in a search image file. Each line of the hiding information in FIG. 5 has a hiding target file name, a search image file name and an accessor IP address.

The hiding information in FIG. 5 has the search image file name as a substitute for the hide area coordinates of the hiding information in FIG. 4. This search image file name retains an image corresponding to the hiding target area.

The WWW server 1 detects the image area designated by the search image file name from the contents of the hiding target file specified by the hiding target file name, and hide this area.

In the hiding information also in FIG. 5, functions of the hiding target file name and the accessor IP address are the same as those in the case of FIG. 4.

<Operation and Effects>

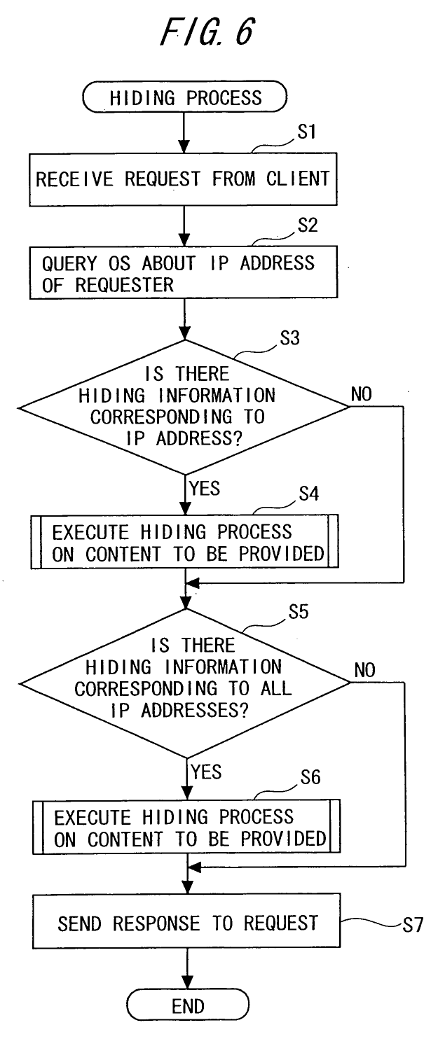

FIG. 6 shows a flowchart of the hiding process executed by the WWW server 1. In this process, at first, the WWW server 1 receives the request from the client (S1).

Thereupon, the WWW server 1 queries an OS about the IP address of the client as a requester (S2).

Then, the WWW server 1 searches for the hiding information (retained in the format in FIG. 4 or FIG. 5), and judges whether or not there exists the hiding information corresponding to this IP address (S3).

In case there exists the hiding information corresponding to this IP address, the WWW server 1 executes the hiding process on the content to be provided (S4). Namely, the WWW server 1 judges whether or not the content as the requested object is designated as the hiding target file (FIG. 4 or FIG. 5). Then, in the case of corresponding to the hiding target file, the WWW server 1 hides the hiding area thereof.

If the judgement in S3 is that the IP address concerned is not defined in the hiding information, the WWW server 1 advances the control to S5.

Next, the WWW server 1 judges whether the hiding information for all the IP addresses is defined or not (S5). The hiding information for all the IP addresses connotes the hiding information defined in the line where nothing is entered in the field of the accessor IP address shown in FIG. 4 or FIG. 5.

If the hiding information for all the IP addresses is defined, the WWW server 1 executes, based on the hiding information, the hiding process on the content to be provided (S6). Whereas if the hiding information for all the IP addresses is not defined, the WWW server 1 lets the control proceed to S7.

Subsequently, the WWW server 1 sends a response to the request (S7). Thereafter, the WWW server 1 terminates the process.

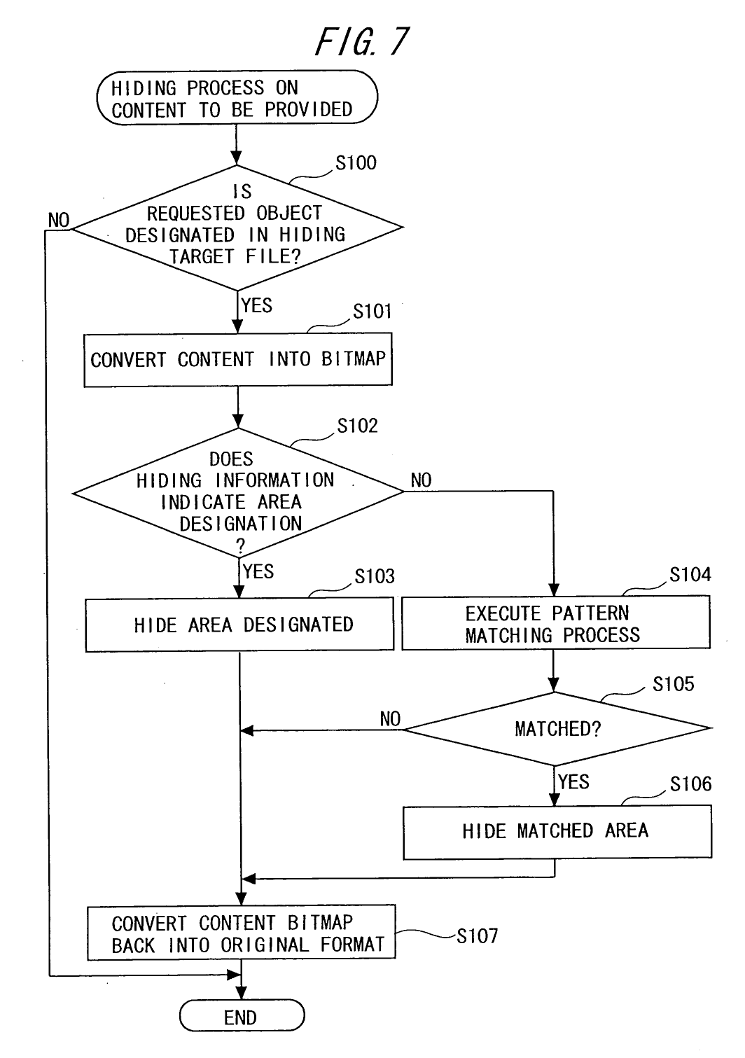

FIG. 7 shows details of the hiding process on the content to be provided (S4 or S6 in FIG. 6). In this process, the WWW server 1, to start with, judges whether or not the requested object is designated in the field of the hiding target file name (S100).

If the requested object is not designated in the field of the hiding target file name, the WWW server 1 finishes the process. Whereas if the requested object is designated in the field of the hiding target file name, the WWW server 1 converts the content as the requested object into the bitmap (S101).

Next, the WWW server 1 judges whether or not the hiding information is an area designation (corresponding to the case in FIG. 4) (S102). If the hiding information is the area designation, the WWW server 1 hides the designated area (designated by the hide area coordinates in FIG. 4) (S103). Thereafter, the WWW server 1 converts the content bitmap back into the original data format (S107). Thereafter, the WWW server 1 finishes the process.

While on the other hand, if the hiding information is not the area designation in the judgement in S102, according to this embodiment, the hiding information is a search image file designation (corresponding to the case in FIG. 5). Then, the WWW server 1 searches for an area corresponding to the image of that search image file from the content bitmap file (created in S101) by a pattern matching process (S104).

Then, the WWW server 1 whether matched or not (S105). If matched, the WWW server 1 hides this matched area (S106). Subsequently, the WWW server 1 converts the content bitmap back into the original data format (S107). Thereafter, the WWW server 1 terminates the process.

Whereas if not matched in the judgement in S105, the WWW server 1 converts, without executing the hiding process, content bitmap back into the original data format (S107). Thereafter, the WWW server 1 finishes the process.

As discussed above, the WWW server 1 in this embodiment hide the image existing area as the hiding information specifies. The hiding information may be fixed coordinate data and may also be bitmap data. In the case of the bitmap data, pattern matching with the bitmap data of the hiding target file is effected, thereby specifying a similar area.

Thus, the data, though originally the same, can be appeared differently depending on the accessing source by giving the information (which is the accessor IP address in FIG. 4 or FIG. 5) showing which piece of hiding information is made effective as the hiding information depending on the address of the accessing source.

Further, the WWW server 1 in this embodiment is capable of partially hiding the image, which enables saving of a labor for creating a file with the image changed by use of a different tool.

Moreover, the WWW server 1 in this embodiment is capable of partially hiding the information irrespective of the format of the hiding target file. For instance, the WWW server 1 can partially hide a hiding target file, other than what has a tag structure as in the HTML file, for example, even a flat bitmapped image.

<Modified Examples>

In the embodiment discussed above, the hiding process has been explained by exemplifying the HTML file or the image file as the hiding target file. The embodiment of the present invention is not, however, limited to these target files. Namely, as discussed in FIG. 1 or FIG. 7, the WWW server 1 in this embodiment converts the hiding object temporarily into the bitmap format and is therefore capable of executing the hiding process without depending on the original data format.

In the embodiment discussed above, the content of the hiding target file is converted temporarily into the bitmap format. The embodiment of the present invention is not, however, limited to this procedure. Namely, the present invention can be embodied by converting the hiding target file into other formats that are possible of the hiding operation, for instance, a vector format, a JPEG (Joint Photographic Experts Group) format, an MPEG (Moving Picture Experts Group) and so on.

In the formats carried out, the hiding process was executed in a way that exemplifies the MTML-formatted or bitmap-formatted content. The object of the present invention may be a dynamic image. That is, a predetermined area in a dynamic image area or an area having a predetermined configuration in the dynamic image may be hidden. In this case, as shown in FIG. 4, coordinates of the predetermined area in each of frames that form the dynamic image, may also be hidden. Further, as shown in FIG. 5, an image of the hide area may be designated by the search image file.

The hiding process itself can be actualized not only by the simply concealing process but also by applying a variety of image effect processes such as image synthesization and so forth.

In the embodiment discussed above, the accessor IP address defined in the hiding information is used for specifying the IP address of the client for which the hiding process should be executed, however, there may be adopted a scheme for controlling so that the hiding process is executed in response to the request given from the client having an address excluding the IP address defined therein.

Moreover, the IP address described in the hiding information may have such a structure that not a complete address but a part of the address is described, and it is judged by detecting a partial coincidence with the IP address of the client as the requester whether the hiding process should be done or not.

The embodiment discussed above has exemplified hiding the predetermined area in the still image and in the dynamic image. The embodiment of the present invention is not, however, limited to the scheme and the procedure described above.

For example, there may be taken such a scheme that a should-be-hidden frame number (frame information) is defined in place of the hide area coordinates of the hiding information, wherein a hiding object is data of an animation composed of a plurality of frames. In the case of adopting such a scheme, response data may be created so that a frame with a number defined in the hiding information becomes not the original data but, e.g., solid black image data on the occasion of reproducing the animation data.

Stream data such as dynamic image data, voice data, etc. can be processing objects of the present invention. For example, in the case of setting the dynamic image as the object, a scheme may be taken, wherein reproducing time information is defined beforehand as a substitute for the hide area coordinates of the hiding information. In the case of adopting such a scheme, the response data may be created so as to reproduce not the original data but, e.g., a solid black scene at the reproducing time defined in the hiding information on the occasion of reproducing the dynamic image data.

Moreover, also in the case of setting the voice data as the object, the reproducing time information is defined beforehand in the hiding information, and the response data may be created so as to reproduce not he original data but a silent state and a different category of data at the reproducing time defined in the hiding information.

<Readable-By-Computer Storage Medium>

A program for actualizing any one of the functions in the embodiment discussed above can be recorded on a readable-by-computer storage medium. Then, the computer reads and executes the program on this storage medium, thereby enabling the computer as the WWW server 1, etc. exemplified in the embodiment given above.

Herein, the readable-by-computer storage medium connotes storage mediums capable of storing information such as data, programs, etc. electrically, magnetically, optically and mechanically or by chemical action, which can be read from the computer. What is demountable out of the computer among those storage mediums is, e.g., a floppy disk, a magneto-optic disk, a CD-ROM, a CD-R/W, a DVD, a DAT, an 8 mm tape, a memory card, etc.

Further, a hard disk, a ROM (Read Only Memory) and so on are given storage mediums fixed to the computer.

<Data Communication Signal Embodied in Carrier Wave>

Furthermore, the above program can be stored in the hard disk and the memory of the computer, and distributed to other computers via communication media. In this case, the program is transmitted as data communication signals embodied in carrier waves via the communication media. Then, the computer receiving the program distributed can be made to function as the WWW server 1 in the embodiment discussed above.

Herein, the communication media may be any one of cable communication mediums such as metallic cables including a coaxial cable and a twisted pair cable, optical communication cables, or wireless communication media such as satellite communications, ground wave wireless communications, etc.

Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave may be any one of a modulated broadband signal and an unmodulated base band signal (corresponding to a case of setting a DC signal having a voltage of 0 as a carrier wave)

### Industrial Applicability

The present invention can be applied to industries for manufacturing information appliances or communication appliances, and to service industries and information providing industries that utilize the information appliances or the communication appliances.

What is claimed is:

1. An apparatus receiving request data from a request source and providing response data corresponding to the request data, comprising:
a control information recording unit recording control information related to an area of which data is restricted from being provided;
an edit unit creating, when the data should be provided as the response data, the response data in accordance with the control information by hiding the data area restricted from being provided; and
a transmitting unit providing the response data.

2. An apparatus receiving request data from a request source and providing response data corresponding to the request data, comprising:
a request source recognizing unit recognizing said request source;
a control information recording unit recording control information related to data restricted from being provided depending on said request source;
an edit unit creating the response data corresponding to the request data in accordance with the control information by hiding an area restricted from being provided; and
a transmitting unit providing the response data.

3. An apparatus according to claim 2, wherein the control information contains information for identifying said request source, and designating information for designating a data area restricted from being provided to said request source.

4. An apparatus according to claim 3, wherein the designating information is display area information for indicating the area restricted from being provided.

5. An apparatus according to claim 3, wherein when the data is an image, the designating information designates a partial image, specifying an object restricted from being provided, in this image.

6. An apparatus according to claim 2, further comprising an input unit setting the control information.

7. A data providing method receiving request data from a request source and providing response data corresponding to the request data, comprising:
a step referring to control information related to an area of which data is restricted from being provided;
a step creating, when the data should be provided as the response data, the response data in accordance with the control information by hiding the data area restricted from being provided; and
a step providing the response data.

8. A data providing method receiving request data from a request source and providing response data corresponding to the request data, comprising:
a step recognizing said request source;
a step referring to control information related to data restricted from being provided depending on said request source;
a step creating the response data corresponding to the request data in accordance with the control information by hiding an area restricted from being provided; and
a step providing the response data.

9. A data providing method according to claim 8, wherein the control information contains information for identifying said request source, and designating information for designating a data area restricted from being provided to said request source.

10. A data providing method according to claim 9, wherein the designating information is display area information for indicating the area restricted from being provided.

11. A data providing method according to claim 9, wherein when the data is an image, the designating information designates a partial image, specifying an object restricted from being provided, in this image.

12. A data providing method according to claim 8, further comprising a step setting the control information.

13. A program executed by a computer receiving request data from a request source and providing response data corresponding to the request data, comprising:
a step referring to control information related to an area of which data is restricted from being provided;
a step creating, when the data should be provided as the response data, the response data in accordance with the control information by hiding the data area restricted from being provided; and
a step providing the response data.

14. A program executed by a computer receiving request data from a request source and providing response data corresponding to the request data, comprising:
a step recognizing said request source;
a step referring to control information related to data restricted from being provided depending on said request source;
a step creating the response data corresponding to the request data in accordance with the control information by hiding an area restricted from being provided; and
a step providing the response data.

15. A program according to claim 14, wherein the control information contains information for identifying said request source, and designating information for designating a data area restricted from being provided to said request source.

16. A program according to claim 15, wherein the designating information is display area information for indicating the area restricted from being provided.

17. A program according to claim 15, wherein when the data is an image, the designating information designates a partial image, specifying an object restricted from being provided, in this image.

18. A program according to claim 14, further comprising a step setting the control information.

19. A storage medium that stored a program executed by a computer receiving request data from a request source and providing response data corresponding to the request data, said program comprising:
a step referring to control information related to an area of which data is restricted from being provided;
a step creating, when the data should be provided as the response data, the response data in accordance with the control information by hiding the data area restricted from being provided; and
a step providing the response data.

20. A storage medium that stored a program executed by a computer receiving request data from a request source and providing response data corresponding to the request data, said program comprising:
a step recognizing said request source;
a step referring to control information related to data restricted from being provided depending on said request source;
a step creating the response data corresponding to the request data in accordance with the control information by hiding an area restricted from being provided; and
a step providing the response data.

21. A storage medium that stored a program according to claim 20, wherein the control information contains information for identifying said request source, and designating information for designating a data area restricted from being provided to said request source.

22. A storage medium that stored a program according to claim 21, wherein the designating information is display area information for indicating the area restricted from being provided.

23. A storage medium that stored a program according to claim 21, wherein when the data is an image, the designating information designates a partial image, specifying an object restricted from being provided, in this image.

24. A storage medium that stored a program according to claim 20, said program further comprising a step setting the control information.

25. An apparatus according to any one of claims 1-6, wherein said apparatus is a server.
